(19) United States
(12) Patent Application Publication
(10) Pub. No.: US 2020/0066018 A1
(43) Pub. Date: Feb. 27, 2020

(54) INFORMATION DISPLAY DEVICE, PROGRAM, AND INFORMATION DISPLAY METHOD

(71) Applicant: MITSUBISHI ELECTRIC CORPORATION, Tokyo (JP)

(72) Inventors: Shinji MAEDA, Tokyo (JP); Yasunori TSUBAKI, Tokyo (JP); Hironobu ABE, Tokyo (JP)

(73) Assignee: MITSUBISHI ELECTRIC CORPORATION, Tokyo (JP)

(21) Appl. No.: 16/607,024

(22) PCT Filed: May 19, 2017
(86) PCT No.: PCT/JP2017/018863

§ 371 Date: Oct. 21, 2019

(51) Int. Cl. G06T 11/60; G06F 17/21; G06F 3/14; G06Q 30/06

(52) U.S. Cl. CPC G06T 11/60; G06Q 30/0641; G06F 3/14; G06F 17/212

(57) ABSTRACT

An information display device having: an operation part to receive input of selection of one screen layout out of a plurality of screen layouts, input of selection of at least one content material to be arranged in the selected one screen layout out of a plurality of content materials, and input of selection of a display area in which the selected at least one content material is arranged out of a plurality of display areas included in the selected one screen layout; a content generation part to generate content screen image data as image data of a content screen image obtained by arranging a content material image of the selected at least one content material in the one screen layout; and a display part to display a content screen image based on the content screen image data.

### TECHNICAL FIELD

The present invention relates to an information display device, a program, and an information display method, and particularly to an information display device, a program, and an information display method for displaying a content screen image.

### BACKGROUND ART

Digital signage is a system for providing contents of advertisement, promotion, guidance, or the like to users by using an information display device such as a display, and widely used in the open air, commercial facilities, transportation facilities, and the like. Digital signage can provide effective contents appropriate to a place where the information display device is installed, by previously editing contents according to tastes of people present at the place.

The Patent Reference 1 discloses a technology of changing sales promotion contents displayed on an information display device by using sales state information obtained from a Point Of Sales (POS) terminal.

The technology described in the Patent Reference 1 sets respective sales goals of a plurality of items in advance, collects information on sales state of each item from the POS terminal, and automatically changes contents displayed on the information display device to contents of an item whose sales goal is unachieved on the basis of the sales goal and the sales state.

Further, the Patent Reference 2 discloses a technology in which a server that distributes contents to information display devices collects information on advertising effectiveness of the contents from the information display device, and generates contents having a higher advertising effect.

According to the technology described in the Patent Reference 2, the distribute server receives measurement information to be used for evaluation of advertising effectiveness of contents from the information display devices, evaluates the advertising effectiveness of the contents, accumulates evaluation results of advertising effectiveness for each contents screen template, and uses a screen template of a high advertising effect in generating contents.

### PRIOR ART REFERENCE

### Patent Reference

Patent Reference 1: Japanese Patent Application Publication No. 2016-118916

Patent Reference 2: Japanese Patent Application Publication No. 2014-52399

### SUMMARY OF THE INVENTION

### Problem to Be Solved By the Invention

In a distribution business, sometimes an item desired to be promoted by all shops in common is different from an item whose sales are focused on by each shop depending on conditions such as customer range, location, weather, inventories, or the like of the shop. However, in the conventional digital signage, contents are generated and distributed by a server which distributes contents to information display devices, and therefore it is difficult for a manger who installs an information display device, i.e. a person in charge of a shop, to use the digital signage by generating contents uniquely based on his or her own will or by selecting contents generated by another shop as contents to display on the information display device.

The technology described in the Patent Reference 1 can automatically change contents displayed on an information display device based on information on sales states of items of one's own shop. However, it is not possible to make the information display device of his or her own shop display the same contents as those of a shop whose sales are brisk among shops treating the same item.

Further, according to the technology described in the Patent Reference 2, the server can use an item template of contents having a high advertising effect when generating contents. However, an item of the contents generated by the server does not necessarily coincide with an item on which a person in charge of a shop wants to focus.

Thus, an object of the present invention is to make it possible to customize appropriately contents distributed by a server.

### Means of Solving the Problem

One mode of the present invention provides an information display device, having: a storage part to store screen layout data indicating a plurality of screen layouts, content material data indicating a plurality of content materials, and content material image data as image data of a plurality of content material images, each of the plurality of screen layouts including a plurality of display areas, each of the plurality of content material images corresponding to image of each of the plurality of content materials; an operation part to receive input of selection of one screen layout out of the plurality of screen layouts, input of selection, out of the plurality of content materials, of at least one content material to be arranged in the one screen layout, and input of selection, out of the plurality of display areas included in the one screen layout, of a display area in which the at least one content material is arranged; a content generation part to identify a content material image of the at least one content material of the plurality of content material images, and to generate content screen image data as image data of a content screen image in which the identified content material image is arranged in the selected display area in the one screen layout; and a display part to display the content screen image based on the content screen image data.

Another mode of the present invention provides a program to make a computer function as: a storage part to store screen layout data indicating a plurality of screen layouts, content material data indicating a plurality of content materials, and content material image data as image data of a plurality of content material images, each of the plurality of screen layouts including a plurality of display areas, each of the plurality of content material images corresponding to image of each of the plurality of content materials; an operation part to receive input of selection of one screen layout out of the plurality of screen layouts, input of selection, out of the plurality of content materials, of at least one content material to be arranged in the one screen layout, and input of selection, out of the plurality of display areas included in the one screen layout, of a display area in which the at least one content material is arranged; a content generation part to identify a content material image of the at least one content material of the plurality of content material images, and to generate content screen image data as image data of a content screen image in which the identified content material image is arranged in the selected display area in the one screen layout; and a display part to display the content screen image based on the content screen image data.

Another mode of the present invention provides an information display method, comprising: receiving input of selection of one screen layout out of a plurality of screen layouts, each of the plurality of screen layouts including a plurality of display areas; receiving input of selection of at least one content material to be arranged in the one screen layout out of a plurality of content materials; receiving input of selection, out of the plurality of display areas included in the one screen layout, of a display area in which the at least one content material is arranged; identifying a content material image of the at least one content material of a plurality of content material images, each of the plurality of content material images corresponding to image of each of the plurality of content materials; and displaying a content screen image in which the identified content material image is arranged in the selected display area in the one screen layout.

### Effects of the Invention

According to one mode of the present invention, it is possible to customize appropriately contents distributed by a server.

### BRIEF DESCRIPTION OF THE DRAWINGS

FIG. 1 is a block diagram illustrating schematically a configuration of a digital signage system as an information display system according to an embodiment 1;

FIG. 2 is a block diagram illustrating schematically a configuration of information display device in the embodiment 1;

FIG. 3 is a schematic diagram illustrating an example of screen layout data in the embodiment 1;

FIG. 4 is a schematic diagram illustrating a first example of screen layout in the embodiment 1;

FIG. 5 is a schematic diagram illustrating a second example of screen layout in the embodiment 1;

FIG. 6 is a schematic diagram illustrating an example of content material data in the embodiment 1;

FIG. 7 is a chart in a table form illustrating attributes of content materials indicated by content material data in the embodiment 1;

FIG. 8 is a schematic diagram illustrating schematically an example of hardware configuration of the information display device in the embodiment 1;

FIG. 9 is a schematic diagram illustrating schematically a configuration of a server in the embodiment 1;

FIG. 10 is a block diagram illustrating schematically an example of hardware configuration of the server in the embodiment 1;

FIG. 11 is a flowchart illustrating operation of the information display device in the embodiment 1;

FIG. 12 is a chart in a table form illustrating the content material data and correspondence relation between selected content material and location;

FIG. 13 is a block diagram illustrating schematically a configuration of a digital signage system as an information display system according to an embodiment 2;

FIG. 14 is a schematic diagram illustrating an example of item data in the embodiment 2;

FIG. 15 is a block diagram illustrating schematically a configuration of an information display device in the embodiment 2;

FIG. 16 is a block diagram illustrating schematically a configuration of a server in the embodiment 2; and

FIG. 17 is a flowchart illustrating operation of the information display device in the embodiment 2.

### MODE FOR CARRYING OUT THE INVENTION

### Embodiment 1

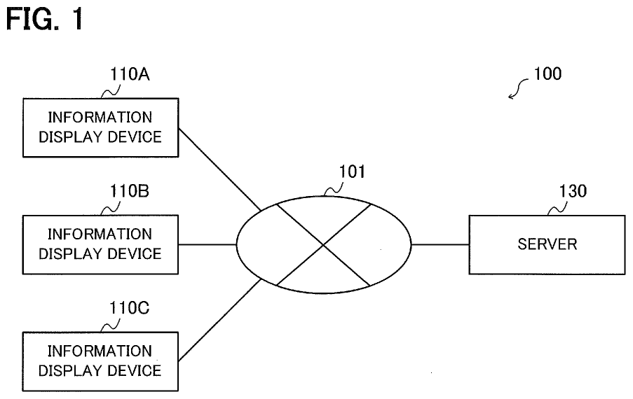

FIG. 1 is a block diagram illustrating schematically a configuration of a digital signage system 100 as an information display system according to an embodiment 1.

The digital signage system 100 has information display devices 110A, 110B, and 110C, and a server 130.

When it is not needed to discriminate each of the information display devices 110A, 110B, and 110C, it is referred to as information display device 110.

The information display device and the server 130 are connected to a network 101.

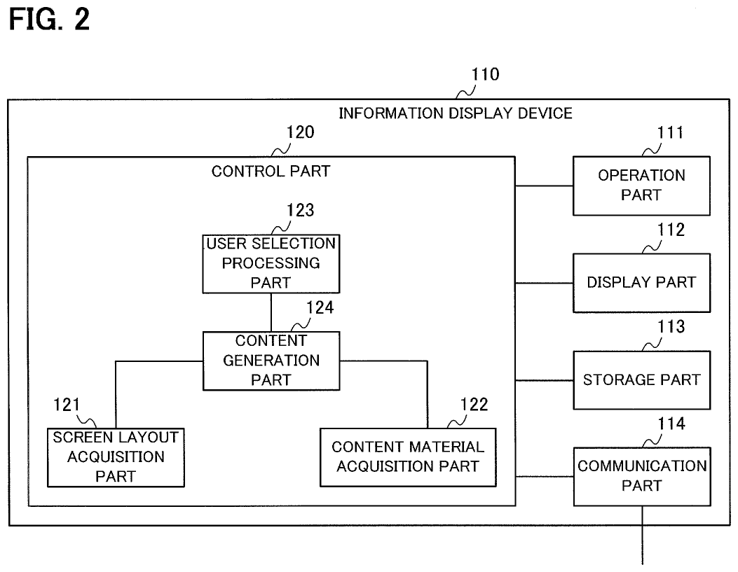

FIG. 2 is a block diagram illustrating schematically a configuration of information display device 110.

The information display device 110 has an operation part 111, a display part 112, a storage part 113, a communication part 114, and a control part 120.

The operation part 111 receives input of operation from a user. For example, as described below, the operation part 111 receives input of selection of one screen layout out of a plurality of screen layouts, input of selection of at least one content material to be arranged in the selected one screen layout out of a plurality of content materials, and input of selection of a display area in which the selected at least one content material is arranged, out of a plurality of display areas held by the selected one screen layout.

Further, as described below, in the case where screen layout data indicate a specific display area and content material data indicate a specific content material to be arranged in that specific display area, the operation part 111 receives input of selection of at least one content material to be displayed in the selected one screen layout, out of the plurality of content materials except that specific content material, and input of selection of a display area in which the selected at least one content material is to be arranged, out of the plurality of display areas except that specific display area.

The display part 112 displays various screen images. For example, the display part 112 displays a content screen image.

The storage part 113 stores data required for processing in the information display device 110.

The communication part 114 communicates with the server 130 via the network 101.

The control part 120 controls the processing in the information display device 110.

The control part 120 has a screen layout acquisition part 121, a content material acquisition part 122, a content generation part 124, and a user selection processing part 123.

The screen layout acquisition part 121 acquires screen layout data that indicate a plurality of screen layouts from the server 130 via the communication part 114. Each of the plurality of screen layouts has a plurality of display areas in which content materials are arranged. The acquired screen layout data are stored in the storage part 113.

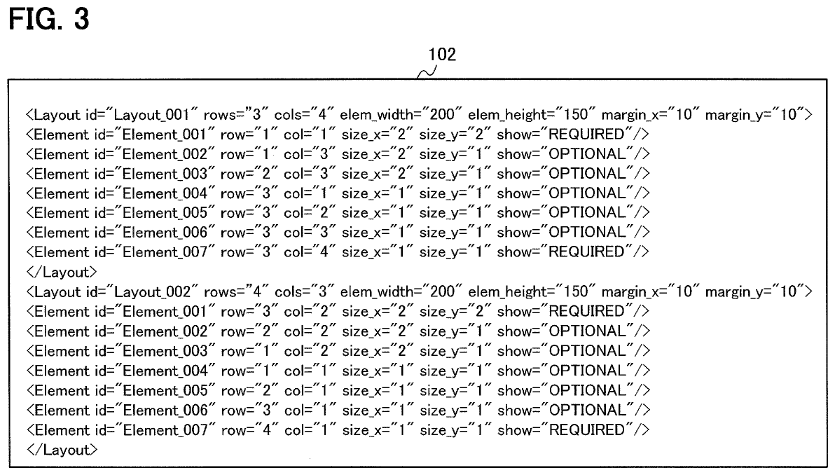

FIG. 3 is a schematic diagram illustrating an example of the screen layout data.

The screen layout data 102 shown in FIG. 3 express a screen layout in the XML format, and express one screen layout by a layout tag <Layout>. The screen layout data 102 shown in FIG. 3 represent two screen layouts “Layout_0001” and “Layout_0002”.

A tag <Layout> expressing each screen layout includes six attributes, i.e. “id”, “rows”, “cols”, “elem_width”, “elem_height”, “margin_x”, and “margin_y”.

The attribute “id” indicates a screen layout ID, which is identification information of the screen layout.

The attribute “rows” indicates the number of rows of elements (i.e. display areas for content materials) that can be arranged in the screen layout. In other words, the attribute “rows” indicates the maximum number of elements that can be arranged in the vertical direction of the screen layout.

The attribute “cols” indicates the number of columns of elements that can be arranged in the screen layout. In other words, the attribute “cols” indicates the maximum number of elements that can be arranged in the horizontal direction of the screen layout.

The attribute “elem_width” indicates width of one row in the screen layout.

The attribute “elem_height” indicates height of one row in the screen layout.

The attribute “margin_x” indicates width of a space between columns in the screen layout.

The attribute “margin_y” indicates width of a space between rows in the screen layout.

For example, in FIG. 3, as for the attributes of the first screen layout, it is shown that the screen layout ID is “Layout_001” (id=“Layout_001”), that the elements are arranged in three rows and four columns (rows=“3”, cols=“4”), that the width of one column is 200 pixels (elem_width=“200”), that the height of one row is 150 pixels (elem_height=“150”), and that the horizontal and vertical margins between elements are each ten pixels (margin_x=“10”, margin_y=“10”).

Further, each screen layout has elements, each of which is expressed by an element tag <Element>.

An element tag <Element> expressing each element includes six attributes, i.e. “id”, “row”, “col”, “size_x”, “size_y”, and “show”.

The attribute “id” indicates an element ID, which is identification information of the element.

The attribute “row” indicates a position in the vertical direction of the upper end of the element. Here, the attribute “row” indicates a row number of the position of the upper end of the element. As a row number, a natural number is assigned sequentially starting with “1” from the upper side of the screen layout.

The attribute “col” indicates a position in the horizontal direction of the upper end of the element. Here, the attribute “col” indicates a column number of the position of the upper end of the element. As a row number, a natural number is assigned sequentially starting with “1” from the left side of the screen layout.

The attribute “size_x” indicates a size of the element in the horizontal direction. Here, the attribute “size_x” indicates the number of columns occupied by the element.

The attribute “size_y” indicates a size of the element in the vertical direction. Here, the attribute “size_y” indicates the number of rows occupied by the element.

The attribute “show” indicates whether display of an image arranged in the element is required or optional.

For example, in FIG. 3, as for the first element of the screen layout “Layout_001”, it is shown that the element ID of the element is “Element_001” (id=“Element_001”), that the position of the upper end of the element is the first row (row=“1”), that the position of the left end of the element is the first column (col=“1”), that the size of the element is two rows by two columns (size_x=“2”, size_y=“2”), and that the display attribute is “required” (show=“required”).

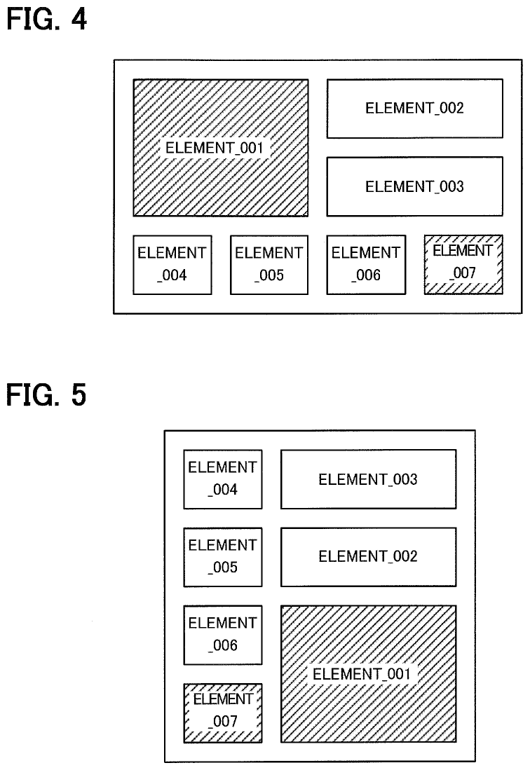

FIG. 4 is a schematic diagram illustrating a screen layout corresponding to the screen layout ID “Layout_001” in the screen layout data 102 shown in FIG. 3.

FIG. 5 is a schematic diagram illustrating a screen layout corresponding to the screen layout ID “Layout_002” in the screen layout data 102 shown in FIG. 3.

As shown in FIGS. 3-5, the screen layout data 102 can indicate a screen layout having elements, which are a plurality of display areas in which content materials can be arranged, in a content screen image displayed on the display part 112.

Further, the screen layout data 102 can indicate that a previously-determined content material is arranged in a specific display area (element), by setting the attribute “show” of the element to “required”.

To return to FIG. 2, the content material acquisition part 122 acquires content material data and thumbnail image data from the server 130. The content material data indicate content materials as components of a content, and the thumbnail image data are image data of thumbnail images as images of the content materials. The acquired content material data and thumbnail image data are stored in the storage part 113. Since the thumbnail images are the images of the content materials, the thumbnail images are also referred to as content material images, and the thumb nail image data are also referred to as content material image data.

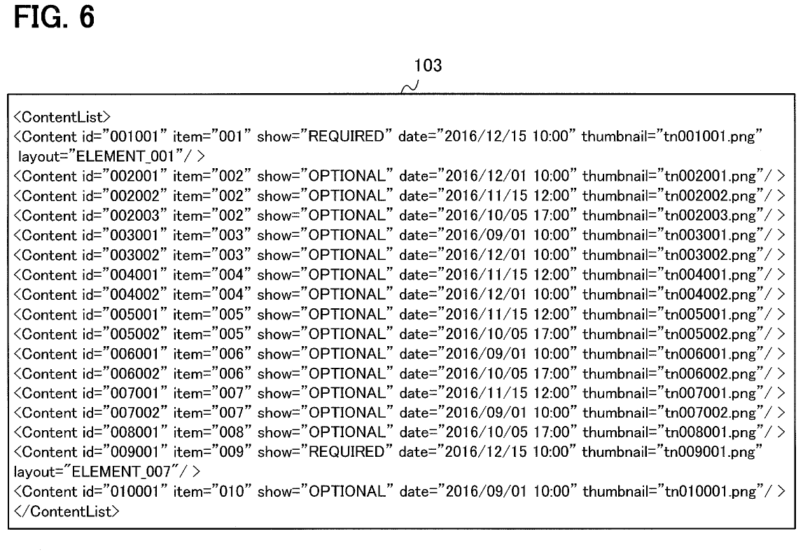

FIG. 6 is a schematic diagram illustrating an example of content material data.

The content material data 103 shown in FIG. 6 express content materials in the XML format, and express one content material by a content tag <Content>. In FIG. 6, the content material data 103 indicated by a content list tag <ContentList> include 17 content materials.

A tag <Content> expressing each content material includes six attributes, i.e. “id”, “item”, “show”, “date”, “thumbnail”, and “layout”.

The attribute “id” indicates a content material ID, which is identification information of the content material.

The attribute “item” indicates an item ID, which is identification information of an item represented by a thumbnail image of the content material.

The attribute “show” indicates whether display of the content material is required or optional.

The attribute “date” indicates date and time at which the thumbnail image data of the content material was generated.

The attribute “thumbnail” indicates a file name of the thumbnail image data of the content material.

The attribute “layout” indicates an element ID corresponding to the arrangement position of the thumbnail image of the content material. In the case where the attribute “layout” is not set, it means that the arrangement position of the thumbnail image of the content material is optional.

For example, in FIG. 6, as for the first content material of the content material data 103 “ContentList”, it is shown that the content material ID is “001001” (id=“001001”), that the item ID is “001” (item=“001”), that the display attribute is “required” (show=“required”), that the date is “2016/12/15 10:00” (date=“2016/12/15 10:00”), that the file name of the thumbnail image is “tn001001.png” (thumbnail=“tn001001.png”), and that the element ID of the arrangement position is “Element_001” (layout=“Element_001”.

As described above, the content material data 103 indicate a plurality of content materials.

Further, by using the attribute “layout”, the content material data 103 can indicate that a specific content material is arranged in a specific display area of a screen layout.

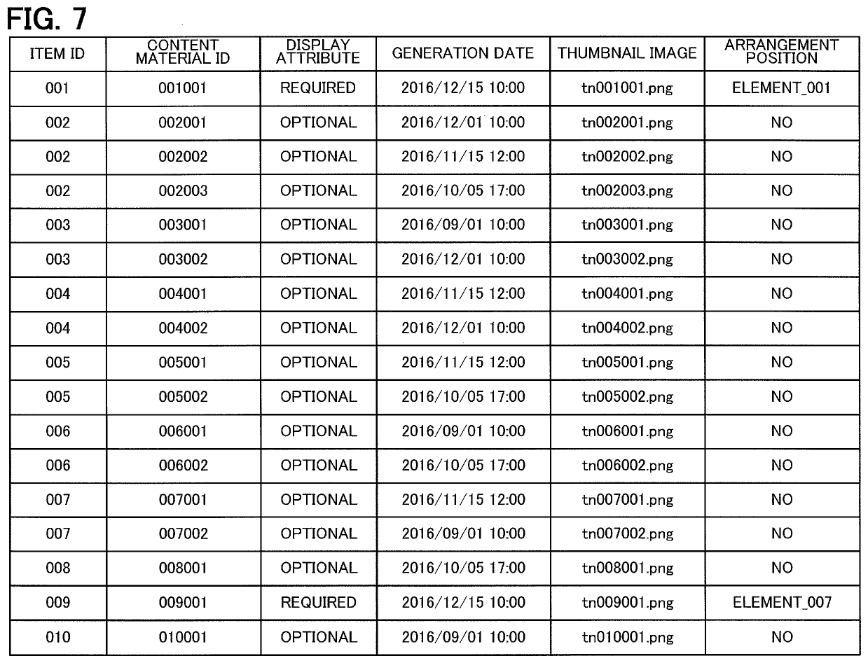

Furthermore, FIG. 7 is a chart in a table form illustrating the attributes of the content materials indicated by the content material data 103 shown in FIG. 6.

To return to FIG. 2, the user selection processing part 123 is a processing part that controls processing of receiving a selection of content materials to be displayed and a selection of a screen layout in which the content materials are arranged, via the operation part 111 and the display part 112.

The content generation part 124 generates content screen image data as image data of a content screen image, based on the screen layout data acquired by the screen layout acquisition part 121, the content material data acquired by the content material acquisition part 122, and the user's selections received by the user selection processing part 123.

For example, in the case where the screen layout data indicate a specific display area and the content material data indicate arrangement of a specific content material in the specific display area, the content generation part 124 identifies the thumbnail image (first content image; first thumbnail image) of the specific content material, and arranges the thumbnail image in the specific display area in one screen layout selected.

Furthermore, the content generation part 124 identifies the thumbnail image (second content image; second thumbnail image) of at least one content material selected and generates content screen image data of the content screen image in which the thumbnail image is arranged in the selected display area in one screen layout selected.

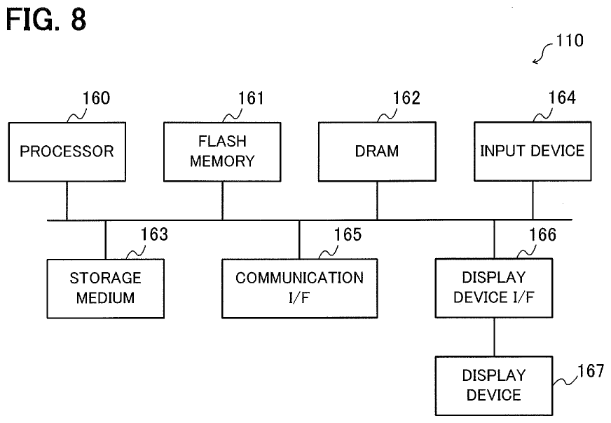

FIG. 8 is a block diagram illustrating schematically an example of hardware configuration of the information display device 110.

The information display device 110 can be implemented by a computer having a processor 160, a flash memory 161, a Dynamic Random Access Memory (DRAM) 162, a storage medium 163, an input device 164, a communication interface (hereinafter referred to as communication I/F) 165, a display unit interface (hereinafter referred to as display unit I/F) 166, and a display device 167.

The processor 160 is a device for executing programs such as an Operating System (OS), various applications, and firmware, accesses the DRAM 162 or the like if necessary, and controls each block of the information display device 110. For example, the control part 120 is implemented by the processor 160 executing a predetermined program. Such a program may be provided via a network, or may be provided being recorded in a storage medium. In other words, such a program may be provided as a program product, for example.

The flash memory 161 is a non-volatile memory that stores programs, such as the OS, applications, and the firmware to be executed by the processor 160.

The DRAM 162 is a volatile memory for temporarily storing the OS, applications, data, or the like when the processor 160 executes a program or the like.

The storage medium 163 is a non-volatile memory for storing the screen layout data, the content material data, and the like, and is implemented by, for example, a Hard Disk Drive (HDD).

For example, the storage part 113 is implemented by the flash memory 161, the DRAM 162, and the storage medium 163.

The input device 164 is keys, buttons, or the like for a user to input an instruction or the like.

For example, the operation part 111 is implemented by the input device 164.

The communication I/F 165 is implemented by, for example, a network interface card or the like, and executes processing of communication with the server 130 via the network 101.

For example, the communication part 114 is implemented by the communication I/F 165.

The display unit I/F 166 executes synthesizing processing of inputted video signal, Graphical User Interface (GUI) screen image, and the like, and outputs the result to the display device 167.

The display device 167 displays various screen images.

For example, the display part 112 is implemented by the display unit I/F 166 and the display device 167.

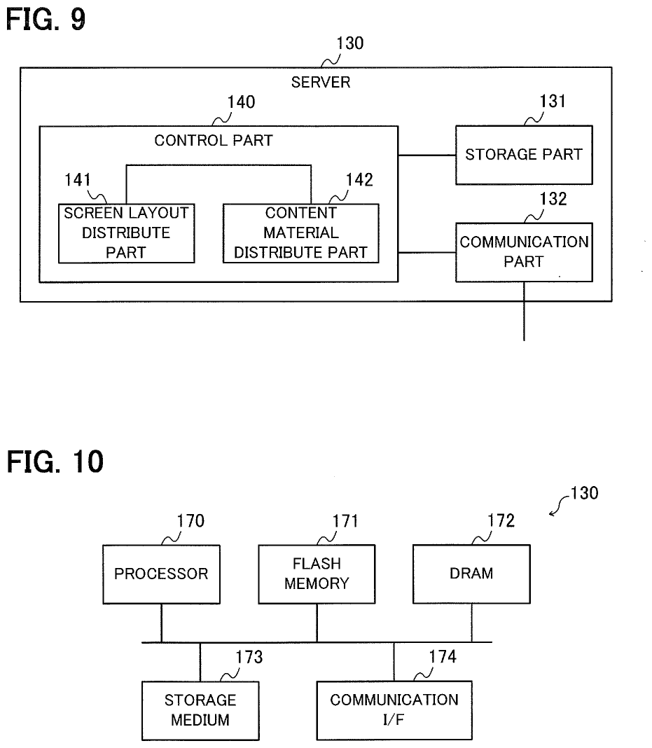

FIG. 9 is a block diagram illustrating schematically a configuration of the server 130 in the embodiment 1.

The server 130 has a storage part 131, a communication part 132, and a control part 140.

The storage part 131 stores data required for processing in the server 130.

The communication part 132 communicates with the information display devices 110 via the network 101.

The control part 140 controls processing in the server 130.

The control part 140 has a screen layout distribute part 141 and a content material distribute part 142.

The screen layout distribute part 141 sends the screen layout data stored in the storage part 131 to an information display device 110 via the communication part 132, in response to a request from the information display device 110.

The content material distribute part 142 sends the content material data and the thumbnail image data stored in the storage part 131 to an information display device 110 via the communication part 132, in response to a request from the information display device 110.

FIG. 10 is a block diagram illustrating schematically an example of hardware configuration of the server 130.

The server 130 can be implemented by a computer comprising a processor 170, a flash memory 171, a DRAM 172, a storage medium 173, and a communication I/F 174.

The processor 170 is a device for executing programs such as an OS, various applications, and firmware, accesses the DRAM 172 or the like if necessary, and controls each block of the server 130. For example, the control part 140 is implemented by the processor 170 executing a predetermined program. Such a program may be provided via a network, or may be provided being recorded in a storage medium. In other words, such a program may be provided as a program product, for example.

The flash memory 171 is a non-volatile memory that stores programs, such as the OS, applications, and the firmware to be executed by the processor 170.

The DRAM 172 is a volatile memory for temporarily storing the OS, applications, data, or the like when the processor 170 executes a program or the like.

The storage medium 173 is a non-volatile memory for storing the screen layout data, the content material data, and the like, and is implemented by, for example, an HDD.

For example, the storage part 131 is implemented by the flash memory 171, the DRAM 172, and the storage medium 173.

The communication I/F 174 is implemented by, for example, a network interface card or the like, and executes processing of communication with an information display device 110 via the network 101.

For example, the communication part 132 is implemented by the communication I/F 174.

Next, operation of the information display device 110 in the embodiment 1 will be described.

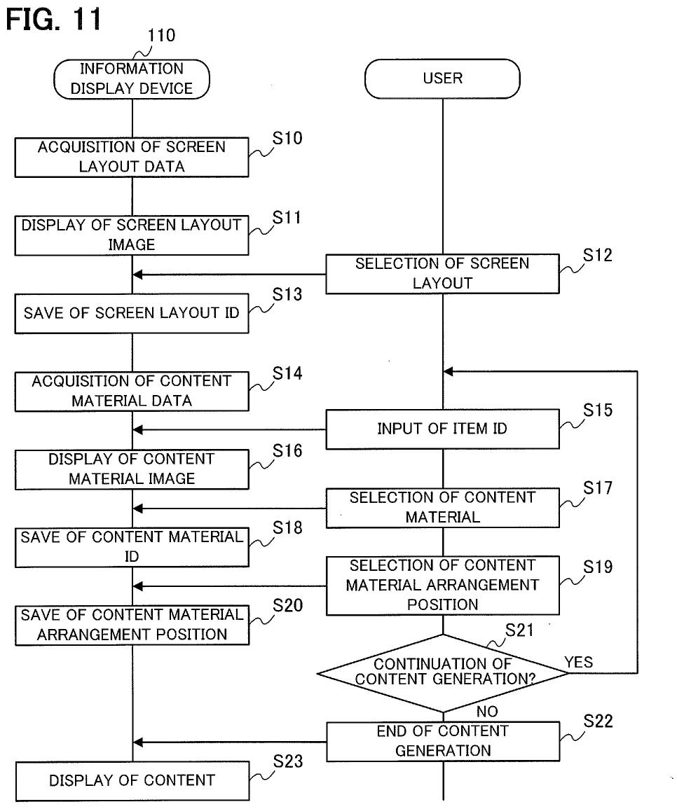

FIG. 11 is a flowchart illustrating operation executed when an information display device 110 connects to the server 130, acquires the screen layout data, the content material data, and the thumbnail image data from the server 130, generates content screen image data, and displays a content screen image.

When the communication part 114 of the information display device 110 connects to the server 130 via the network 101, first the screen layout acquisition part 121 acquires the screen layout data (S10).

Then, the user selection processing part 123 displays a list of screen layouts on the display part 112 based on the acquired screen layout data (S11). For example, the user selection processing part 123 generates screen layout image data that are image data of thumbnail images (screen layout images) of the screen layouts by reducing the scale of each of the screen layouts indicated by the acquired screen layout data, at a predetermined reduction rate, and makes the display part 112 display the list of the screen layouts based on the screen layout image data. In other words, the user selection processing part 123 makes the display part 112 display a plurality of screen layout images as a list of screen layouts.

Next, when a user selects a thumbnail image of one screen layout out of the list of the screen layouts by using the operation part 111 (S12), the user selection processing part 123 saves the screen layout ID of the screen layout corresponding to the selected thumbnail image, by storing the screen layout ID to the storage part 113 (S13).

Further, the content material acquisition part 122 acquires the content material data and the thumbnail image data of the content materials (S14).

When the user inputs, into the information display device 110 with the operation part 111, an item ID that is the identification information of an item whose content material the user wants to display (S15), the user selection processing part 123 makes the display part 112 display a list of thumb nail images corresponding to the inputted item ID based on the acquired content material data and thumbnail image data (S16). Here, the user selection processing part 123 may reduce the scales of the thumbnail images indicated by the thumbnail image data and make the display part 112 display a list of the reduced thumbnail images.

Next, when the user selects one thumbnail image out of the list of the thumbnail images by using the operation part 111 (S17), the user selection processing part 123 saves the content material ID of the content material corresponding to the selected thumbnail image, by storing the content material ID to the storage part 113 (S18).

Further, when, by using the operation part 111, the user selects an element as an arrangement position of the content material selected in the step S17 in the screen layout selected in the step S12 (S19), the user selection processing part 123 saves the element ID indicating the arrangement position of the selected content material, by storing the element ID to the storage part 113 (S20). For example, the user selection processing part 123 may display the thumbnail image (for example, FIG. 4 or FIG. 5) of the screen layout selected in the step S12 on the display part 112, to receive selection of arrangement position (“Element” shown in FIG. 4 or 5) of the content material selected in the step S17 from the user via the operation part 111.

Then, if the user continues the content generation (Yes in S21), the processing returns to the step S15.

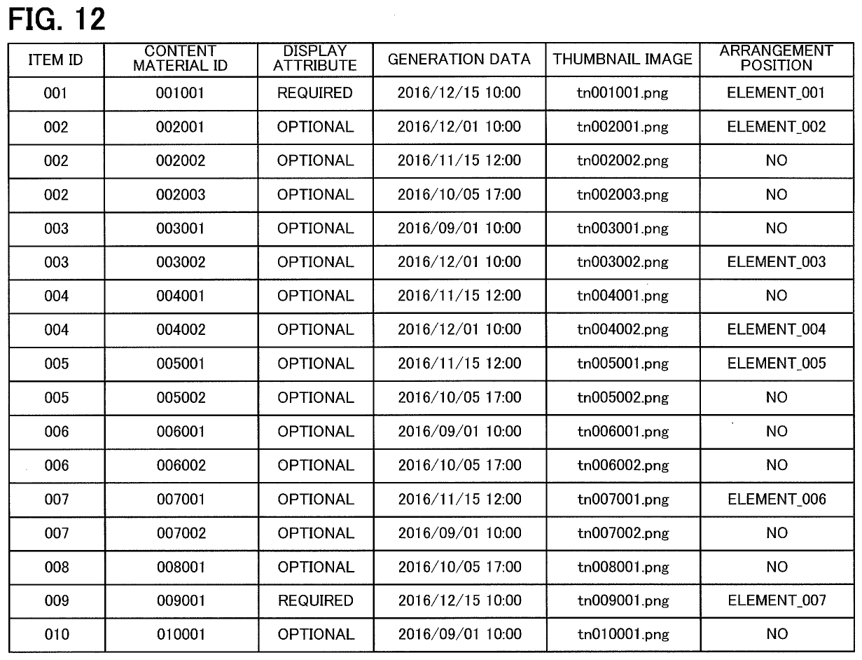

On the other hand, if the user ends the content generation (No in S21), the user inputs end of the content generation with the operation part 111 (S22). FIG. 12 is a chart in a table form illustrating the content material data and correspondence relation between selected content material and location.

As a result, the content generation part 124 generates content screen image data by arranging the thumbnail image of the content material selected in the step S17 in the arrangement position selected in the step S19 in the screen layout selected in the step S12. Then, the content generation part 124 sends the generated content screen image data to the display part 112, to make the display part 112 display the content screen image (S23).

As described hereinabove, according to the embodiment 1, when an information display device 110 generates a content screen image, the information display device 110 selects content materials based on the display attributes of the content materials and arranges the selected content materials in the screen layout. Accordingly, a content screen image can be suitably customized by setting the display attribute to “required” with respect to content materials of items that are desired to be displayed commonly in all the information display devices 110, and by setting the display attribute to “optional” with respect to a content material of an item that is to be displayed independently in each information display device 110.

### Embodiment 2

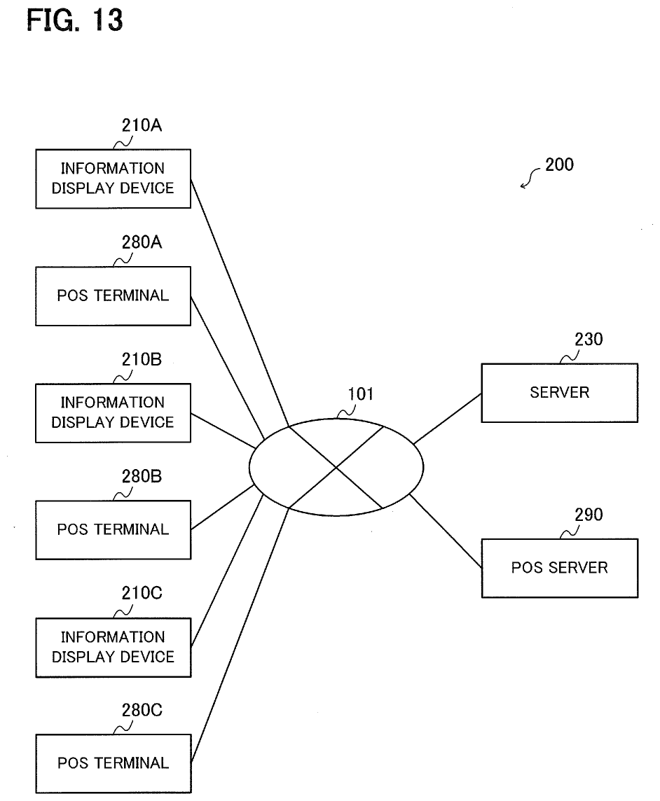

FIG. 13 is a block diagram illustrating schematically a configuration of a digital signage system 200 as an information display system according to an embodiment 2.

The digital signage system 200 has information display devices 210A, 210B, and 210C, a server 230, POS terminals 280A, 280B, and 280C, and a POS server 290.

When it is not necessary to discriminate each of the information display devices 210A, 210B, and 210C, it is referred to as information display device 210.

When it is not necessary to discriminate each of the POS terminals 280A, 280B, and 280C, it is referred to as POS terminal 280.

The information display devices, the server 130, the POS terminals 280, and the POS server 290 are connected to a network 101.

A POS terminal 280 is installed in each shop and sends sales data of items sold in the shop to the POS server 290. The sales data includes, for each item, an item ID, which is identification information of the item; a shop ID, which is identification information of the shop in which the POS terminal 280 is installed; a content material ID (displayed content material ID), which is identification information of a content material (displayed content material) that corresponds to the item and that is used in a content screen image displayed in the shop in which the POS terminal 280 is installed; and sales amount as information indicating sales amount of the item.

The POS server 290 totals up, for each item, sales data sent from the POS terminals 280, to generate item data for each item.

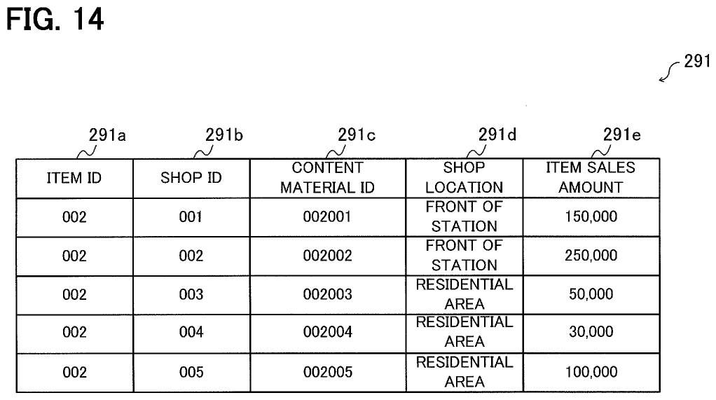

FIG. 14 is a schematic diagram illustrating an example of item data.

The item data 291 are data in a table form obtained by totaling up sales data of the corresponding item for each shop.

The item data 291 has an item ID column 291a, a shop ID column 291b, a content material ID column 291c, a shop location column 291d, and an item sales amount column 291e.

The item ID column 291a stores the item ID of the item as the object of the item data 291.

The shop ID column 291b stores a shop ID of a shop in which a POS terminal 280 is installed.

The content material ID column 291c stores a content material ID (displayed content material ID) of a content material (displayed content material) used, with respect to the item as the object of the item data 291, in a content screen image displayed in a shop in which a POS terminal 280 is installed.

The shop location column 291d stores information indicating a location of a shop in which a POS terminal 280 is installed. It is assumed here that the information indicating a location of a shop is previously stored in the POS server 290 for every shop.

The item sales amount column 291e stores sales amount of the item as the object of the item data 291, for each shop.

The item data as described above are generated by the POS server 290 and sent to the server 230.

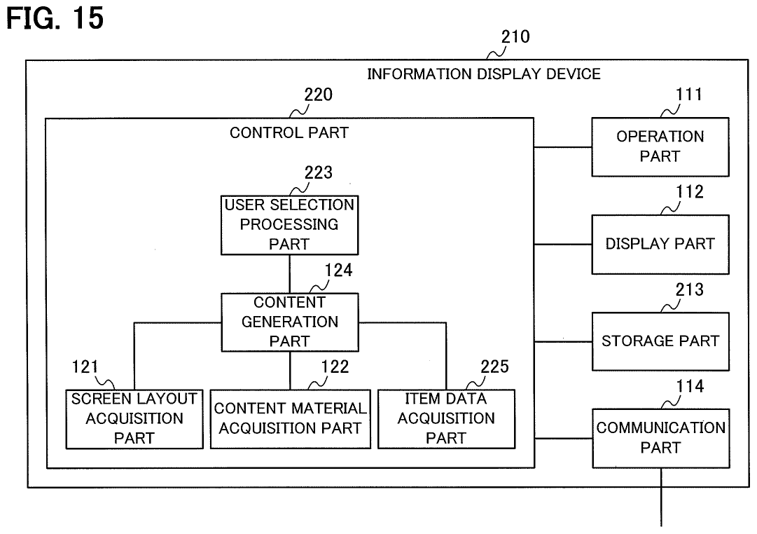

FIG. 15 is a block diagram illustrating schematically a configuration of information display device 210 in the embodiment 2.

The information display device 210 has an operation part 111, a display part 112, a storage part 213, a communication part 114, and a control part 220.

The operation part 111, the display part 112, and the communication part 114 of the information display device 210 in the embodiment 2 are similar to those in the embodiment 1.

The storage part 213 stores data required for processing in the information display device 210. In the embodiment 2, the information display device 210 stores also item data acquired from the server 230.

The control part 220 controls the processing in the information display device 210.

The control part 220 has a screen layout acquisition part 121, a content material acquisition part 122, a content generation part 124, a user selection processing part 223, and an item data acquisition part 225.

The screen layout acquisition part 121, the content material acquisition part 122, and the content generation part 124 of the control part 220 in the embodiment 2 are similar to those in the embodiment 1.

The item data acquisition part 225 acquires item data from the server 230 via the communication part 114. The acquired item data are stored in the storage part 213.

The user selection processing part 223 controls processing of receiving a selection of content materials to be displayed and a selection of a screen layout in which the content materials are arranged, via the operation part 111 and the display part 112. In the embodiment 2, the user selection processing part 223 receives the selection of content materials to be displayed from the item data acquired from the server 230.

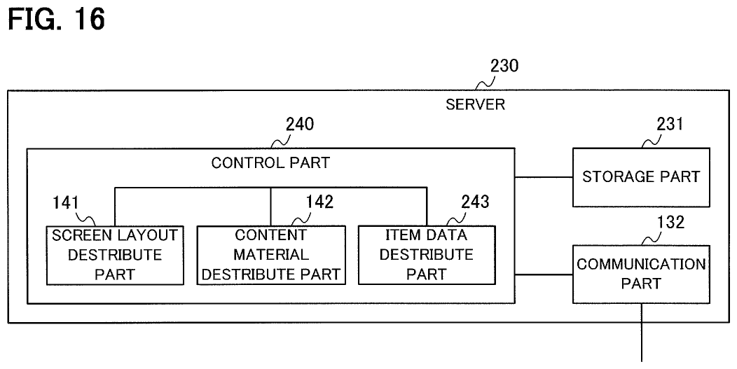

FIG. 16 is a block diagram illustrating schematically a configuration of the server 230 in the embodiment 2.

The server 230 has a storage part 231, a communication part 132, and a control part 240.

The communication part 132 of the server 230 in the embodiment 2 is similar to that in the embodiment 1.

The storage part 231 stores data required for processing in the server 230. In the embodiment 2, the storage part 231 stores also item data acquired from the POS server 290.

The control part 240 controls the processing in the server 230.

The control part 240 has a screen layout distribute part 141, a content material distribute part 142, and an item data distribute part 243.

The screen layout distribute part 141 and the content material distribute part 142 of the control part 240 in the embodiment 2 are similar to those in the embodiment 1.

The item data distribute part 243 acquires item data from the POS server 290 via the communication part 132, and stores the acquired item data to the storage part 231.

Further, the item data distribute part 243 sends the item data stored in the storage part 231 to an information display device 210 via the communication part 132 in response to a request from the information display device 210.

Next, operation of the information display device 210 in the embodiment 2 will be described.

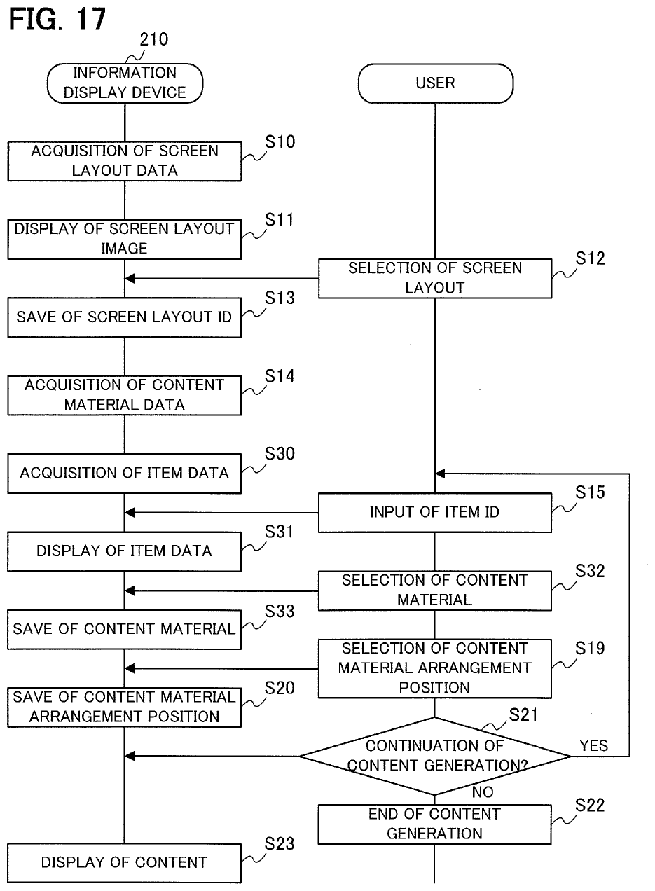

FIG. 17 is a flowchart illustrating operation executed when an information display device 210 connects to the server 230, acquires the screen layout data, the content material data, the thumbnail image data, and the item data from the server 230, generates content screen image data, and displays a content screen image.

Among the steps of the flowchart shown in FIG. 17, steps similar to those of the flowchart shown in FIG. 11 are given the same reference characters as those in FIG. 11.

The steps S10-S14 in FIG. 17 are similar to the steps S10-S14 in FIG. 11. In FIG. 17, however, after the step S14, the processing proceeds to the step S30.

In the step S30, the item data acquisition part 225 acquires the item data.

Then, when a user inputs, into the information display device 210 with the operation part 111, an item ID as the identification information of an item whose content material is desired to be displayed (S15), the user selection processing part 223 displays the item data corresponding to the inputted item ID on the display part 112 (S31). Here, the user selection processing part 223 may display not only the item data but also a list of thumbnail images corresponding to the inputted item ID on the display part 112, based on the acquired content material data and the acquired thumbnail image data.

Next, when the user selects one content material ID out of the item data by using the operation part 111, the user selection processing part 223 saves the selected content material ID by storing the selected content material ID to the storage part 213 (S33).

For example, in the case where a person in charge of a shop located in “residential area” generates a content screen image for promotion of an item of an item ID “002” based on the item data 291 shown in FIG. 14, it is expected that the advertising effect equivalent to the shop attaining the largest sales can be obtained by selecting the content material ID “002005” used by the shop ID “005” of the largest sales of the item of the item ID “002” among the three shops of the shop IDs “003”-“005” located in “residential area” which is the same location condition as that of its own shop.

Then, the processing proceeds to the step S19. The subsequent steps S19-S23 are similar to the steps S19-S23 of FIG. 11.

As described above, according to the embodiment 2, at the time of generating a content screen image, a user of the information display device 210, i.e. a person in charge of a shop, can generate a content screen image having larger advertising effect by referring to the content screen images used by the other shops, when the user selects a content material and arranges the selected content material in a screen layout based on the item data including the shop's location conditions and the item's sales amount.

As another way, an information display device 110, 210 sends content screen image data generated in the information display device 110, 210 itself to the server 130, 230, and the server 130, 230 stores (saves) the content screen image data, so that another information display device 110, 210 can also use the content screen image data stored in the server 130, 230 without change. In that case, the content screen image data have been associated with the sales amount of items included in the content screen image data, so that a user of another information display device 110, 210 can use the content screen image data having larger advertising effect.

### DESCRIPTION OF REFERENCE CHARACTERS

100, 200: digital signage system; 110, 210: information display device; 111: operation part; 112: display part; 113: storage part; 114: communication part; 120, 220: control part; 121: screen layout acquisition part; 122: content material acquisition part; 123, 223: user selection processing part; 124: content generation part; 225: item data acquisition part; 130, 230: server; 280: POS terminal; and 290: POS server.

1-10. (canceled)

11. An information display device comprising:
a memory to store screen layout data indicating a plurality of screen layouts, content material data indicating a plurality of content materials, content material image data as image data of a plurality of content material images, item data including information on sales amount of an item corresponding to a displayed content material in a shop displaying a content screen image in which a content material image of the displayed content material as a content material selected out of the plurality of content materials is arranged, and a program, each of the plurality of screen layouts including a plurality of display areas, each of the plurality of content material images corresponding to image of each of the plurality of content materials;
an input device to receive input of selection of one screen layout out of the plurality of screen layouts, input of selection, out of the plurality of content materials, of at least one content material to be arranged in the one screen layout, and input of selection, out of the plurality of display areas included in the one screen layout, of a display area in which the at least one content material is arranged;
a display device to display a content screen image based on a content screen image data; and
a processor to execute the program,
wherein the program which, when executed by the processor, performs processes of,
identifying a content material image of the at least one content material out of the plurality of content material images;
generating the content screen image data as image data of the content screen image in which the identified content material image is arranged in the selected display area in the one screen layout;
making the display device display a plurality of screen layout images based on the screen layout data;
making the display device display information indicating sales amount of the item corresponding to the displayed content material based on the item data, each of the plurality of screen layout images indicating each of the plurality of screen layouts; and
wherein the input device receives input of selection of one screen layout image out of the plurality of screen layout images, as the input of selection of the one screen layout, and receives input of selection of the displayed content material, as the input of selection of the at least one content material.

12. An information display device of claim 11, wherein:
the screen layout data further indicates that a predetermined content material is arranged in a specific display area of the plurality of display areas included in each of the plurality of screen layouts;
the content material data further indicates that a specific content material of the plurality of content materials is arranged in the specific display area; and
the input device receives input of selection of the at least one content material to be displayed in the one screen layout out of the plurality of content materials except the specific content material, and input of selection, out of the plurality of display areas except the specific display area, of the display area in which the at least one content material is arranged; and
the program which, when executed by the processor, further performs processes of specifying, as a first content material image, a content material image of the specific content material out of the plurality of content material images, specifying, as a second content material image, a content material image of the at least one content material out of the plurality of content material images, arranges the first content material image in the specific display area in the one screen layout, and arranging the second content material image in the selected display area in the one screen layout.

13. An information display device of claim 11, wherein:
the program which, when executed by the processor, further performs process of making the display device display the plurality of content material images based on the content material image data; and
the input device receives input of selection of a content material image of a content material to be arranged in the one screen layout out of the plurality of content material images, as the input of selection of the at least one content material.

14. An information display device of claim 11, further comprising a communication interface to communicate with a server,
wherein the program which, when executed by the processor, further performs processes of,
acquiring the screen layout data from the server via the communication interface;
storing the screen layout data to the memory;
acquiring the content material data and the content material image data from the server via the communication interface; and
storing the content material data and the content material image data to the memory.

15. An information display device of claim 11, wherein:
the item data further indicates information on a location of the shop; and
the program which, when executed by the processor, further performs process of making the display device display the information on the location of the shop as well as the information indicating the sales amount of the item corresponding to the displayed content material.

16. An information display device of claim 11, further comprising a communication interface to communicate with a server,
wherein the program which, when executed by the processor, further performs processes of;
acquiring the screen layout data from the server via the communication interface;
storing the screen layout data to the memory;
acquiring the content material data and the content material image data from the server via the communication interface;
storing the content material data and the content material image data to the memory;
acquiring the item data from the server via the communication interface; and
storing the item data to the memory.

17. A non-transitory computer-readable medium that stores therein a program causing a computer to execute processes of:
receiving input of selection of one screen layout out of a plurality of screen layouts, each of the plurality of screen layouts including a plurality of display areas;
receiving input of selection of at least one content material to be arranged in the one screen layout out of a plurality of content materials;
receiving input of selection, out of the plurality of display areas included in the one screen layout, of a display area in which the at least one content material is arranged;
identifying a content material image of the at least one content material out of a plurality of content material images, each of the plurality of content material images corresponding to image of each of the plurality of content materials;
displaying a content screen image in which the identified content material image is arranged in the selected display area in the one screen layout;
displaying a plurality of screen layout images, each of the plurality of screen layout images indicating each of the plurality of screen layouts; and
displaying information indicating sales amount of the item corresponding to a displayed content material in a shop displaying a content screen image in which a content material image of the displayed content material as a content material selected out of the plurality of content materials is arranged, wherein
input of selection of one screen layout image out of the plurality of screen layout images is received as the input of selection of the one screen layout; and
input of selection of the displayed content material is received as the input of selection of the at least one content material.

18. An information display method, comprising:
receiving input of selection of one screen layout out of a plurality of screen layouts, each of the plurality of screen layouts including a plurality of display areas;
receiving input of selection of at least one content material to be arranged in the one screen layout out of a plurality of content materials;
receiving input of selection, out of the plurality of display areas included in the one screen layout, of a display area in which the at least one content material is arranged;
identifying a content material image of the at least one content material out of a plurality of content material images, each of the plurality of content material images corresponding to image of each of the plurality of content materials;
displaying a content screen image in which the identified content material image is arranged in the selected display area in the one screen layout;
displaying a plurality of screen layout images, each of the plurality of screen layout images indicating each of the plurality of screen layouts; and
displaying information indicating sales amount of the item corresponding to a displayed content material in a shop displaying a content screen image in which a content material image of the displayed content material as a content material selected out of the plurality of content materials is arranged, wherein
input of selection of one screen layout image out of the plurality of screen layout images is received as the input of selection of the one screen layout; and
input of selection of the displayed content material is received as the input of selection of the at least one content material.
